(19) United States
(12) Patent Application Publication
(10) Pub. No.: US 2014/0263718 A1
(43) Pub. Date: Sep. 18, 2014

(54) Straw with hygiene pick

(71) Applicant: Kathie Ann Marouthis, Deerfield Beach, FL (US)

(72) Inventor: Kathie Ann Marouthis, Deerfield Beach, FL (US)

(21) Appl. No.: 13/815,846

(22) Filed: Mar. 15, 2013

(51) Int. Cl. A47G 21/18; A61C 15/02

(52) U.S. Cl. CPC A47G 21/18; A61C 15/02
USPC 239/33

(57) ABSTRACT

A drinking straw including means for dislodging food particles stuck, for example, between teeth is disclosed. The drinking straw includes a projection which is narrower than the diameter of the straw cylinder and operable to dislodge matter from between teeth. The projection may be attached to the cylinder in such a way that that it can be removed from the drinking straw.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

1. Field of the Invention

The invention concerns the fields of drinking straws and oral hygiene.

2. Description of the State of the Art

A straw is a prepared tube used to suck a beverage out of a container. Historians theorize the first straws were cut from dried wheat shafts and they were named accordingly.

A basic drinking straw is a cylinder having first and second ends that are open so that, when one end is in a liquid, such as a beverage in a glass, and a person creates negative pressure in the cylinder as by sucking on the other end of the straw, atmospheric pressure pushes liquid into and up the cylinder to the other end of the straw and into the person's mouth for ingestion.

Methods have been developed to mass produce straws. In one method, elongated sheets of wax-coated paper are rolled into a cylindrical, hollow tube by coiling paraffin-coated paper around a rod-shaped form and then securing the paper with an adhesive. The straws are then coated with wax to further water-proof them. The wax coating is important since the straw is paper and would eventually absorb some of the liquid. After some use, these paper straws became soggy and useless.

In the 1960s, plastic technology developed to a point where straws were manufactured from plastic using extrusion processes. Today, straws are made in a wide variety of shapes and colors. Variations on straw designs are also plentiful. A bendable straw or “bendy straw” has a concertina-type hinge near the top for convenience. A “crazy” straw is hard plastic and has a number of twists and turns at the top. When liquid is sucked through the straw, it quickly flows through the winding path, creating a mildly entertaining spectacle. A spoon straw features a cut-away shape at one end that functions as a miniature spoon and is intended for slush drinks. Candy straws, such as licorice straws, are made from different types of chewy candy. Miniature straws often come attached to a drink box. A wide straw is used for sipping bubble tea and also for stirring beverages. “Sanitary” straws are individually wrapped to avoid contamination. A drinking straw known as the Sipahh contains tapioca beads that dissolve as milk passes over them to add color and flavor. A recent addition to the straw family is the cereal straw, such as the ones made by Kelloggs. Special “color-changer” straws given with meals at Friendly's change color as cold liquid passes through them.

Recent innovation in straw technology is reflected in a recent patent, U.S. Pat. No. 7,845,513, which describes a drink container, a drink container lid and a straw releasably supported within the lid.

Very often, beverages are paired with food. Some believe that, when straws are used to drink sugary beverages, there is a decreased chance of tooth decay because there is less contact between the teeth and the beverage. However, when beverages, sugary or not, are paired with food, pieces of food sometimes become lodged between teeth and this can cause many problems including decay, halitosis, and unsightliness. When this happens, one can use a toothpick to try to dislodge the piece of food. Some eating establishments offer toothpicks at the cashier station, although this is extremely rare in fast food establishments. In more upscale eating establishments, sometimes one can find a toothpick which can be used to dislodge a piece of food from between teeth although some patrons might consider this to be crass—a breach of good manners, if you will. The present invention provides a solution to the dilemma encountered when food becomes lodged and a toothpick is not readily available. In virtually every eating establishment, a patron who orders a beverage will be provided with a straw for that beverage or, if not, a straw will be provided upon request. The present invention provides means for dislodging food particles together with a cylinder that functions as a straw.

Accordingly, it is an object of the invention to provide a straw with integral means for removing food particles lodged in a person's mouth.

It is a further object of the invention to provide such a straw wherein the means for dislodging food particles do not inhibit the function of the straw.

It is still another object of the invention to provide such a straw wherein the means for dislodging food particles can be removed from the straw.

These and other objects and advantages of the present invention shall be apparent from the following detailed description with reference, therein, to the several drawing figures.

### BRIEF DESCRIPTION OF THE SEVERAL VIEWS OF THE DRAWING

FIG. 1 is a right bottom perspective view of a first example of my invention;

FIG. 2 is a left bottom perspective view of the first example of my invention;

FIG. 3 is a plan view of the first example of my invention;

FIG. 4 is a right bottom perspective view of a second example of my invention;

FIG. 5 is a left bottom perspective view of the second example of my invention;

FIG. 6 is a plan view of the second example of my invention;

FIG. 7 is a right bottom perspective view of a third example of my invention;

FIG. 8 is a left bottom perspective view of the third example of my invention;

FIG. 9 is a plan view of the third example of my invention;

FIG. 10 is a right bottom perspective view of a fourth example of my invention;

FIG. 11 is a left bottom perspective view of the fourth example of my invention;

FIG. 12 is a plan view of the fourth example of my invention;

FIG. 13 is a right bottom perspective view of a fifth example of my invention;

FIG. 14 is a left bottom perspective view of the fifth example of my invention;

FIG. 15 is a plan view of the fifth example of my invention;

FIG. 16 is a right bottom perspective view of a fifth example of my invention showing the projection in a different orientation;

FIG. 17 is a right bottom perspective view showing a feature of some of the examples of my invention;

FIG. 18 is a left bottom perspective view showing the feature illustrated in FIG. 17;

FIG. 19 is a plan view showing the feature illustrated in FIGS. 17 and 18.

### DETAILED DESCRIPTION OF REPRESENTATIVE EMBODIMENTS OF THE INVENTION

Referring now to FIGS. 1, 2 and 3, a straw according to one example of my invention is indicated generally at 10. The straw 10 includes a hollow, generally cylindrical portion 12 having a first end 14. In this example, the end 14 is generally square, i.e., it is perpendicular to the axis of the cylinder 12. Opposite the first end 14 of the cylinder 12 there is a second end indicated generally at 16. An edge 18 at the second end 16 of the cylinder 12 is a given distance from the first end 14 of the cylinder 12. A projection 20 extends beyond the edge 18 and terminates in a tip 22 which is more than the given distance from the end 14. In this example, the projection 20 is integral with the cylinder 12. The projection 20 has a width that is less than the diameter of the cylinder 12 and a length that is longer than the diameter of the cylinder 12. Curved portions 24 extend from the edge 18 to sides 26 of the projection 20. In this example, the sides 26 are substantially parallel between the tip 22 and the curved portions 24. The projection 20 is useful for removing particles of food from between teeth.

Referring now to FIGS. 4, 5, and 6, a straw according to a second example of my invention is indicated generally at 30. The straw 30 includes a hollow, generally cylindrical portion 32 having a first end 34. In this example, the end 34 is generally square, i.e., it is perpendicular to the axis of the cylinder 32. Opposite the first end 34 of the cylinder 32 there is a second end indicated generally at 36. An edge 38 at the second end 36 of the cylinder 32 is a given distance from the first end 34 of the cylinder 32. A projection 40 extends beyond the edge 38 and terminates in a tip 42 which is more than the given distance from the end 34. In this example, the projection 40 is integral with the cylinder 32. The projection 40 has a width that is less than the diameter of the cylinder 32 and a length that is longer than the diameter of the cylinder 32. Curved portions 44 extend from the edge 38 to sides 46 of the projection 40. In this example, the sides 46 are not substantially parallel between the tip 42 and the curved portions 44. The sides 46 are tapered so that they are closer together where they are adjacent to the tip 42 than they are where they are adjacent to the curved portions 44. The length of the projection 40 is longer than the length of the projection 20. The projection 40 is useful for removing particles of food from between teeth.

Referring now to FIGS. 7, 8, and 9, a straw according to a third example of my invention is indicated generally at 50. The straw 50 includes a hollow, generally cylindrical portion 52 having a first end 54. In this example, the end 54 is generally square, i.e., it is perpendicular to the axis of the cylinder 52. Opposite the first end 54 of the cylinder 52 there is a second end indicated generally at 56. An edge 58 at the second end 56 of the cylinder 52 is a given distance from the first end 54 of the cylinder 52. A projection 60 extends beyond the edge 58 and terminates in a tip 62 which is more than the given distance from the end 54. In this example, the projection 60 is integral with the cylinder 52. The projection 60 has a width that is less than the diameter of the cylinder 52 and a length that is longer than the diameter of the cylinder 52. Curved portions 64 extend from the edge 58 to sides 66 of the projection 60. In this example, the sides 66 are not substantially parallel between the tip 22 and the curved portions 24. The portion of the projection 60 that is connected to the curved portions 64 is wider than the corresponding portions of the projections 20 and 40. The length of the projection 60 is greater than the length of the projections 20 and 40. The sides 66 are tapered so that they are closer together where they are adjacent to the tip 62 than they are where they are adjacent to the curved portions 64. The width of the portion of the projection 60 that is adjacent to the curved portions 64 is less than, but nearly equal to, the diameter of the cylinder 52. The projection 60 is useful for removing particles of food from between teeth.

Referring now to FIGS. 10, 11, and 12, a straw according to fourth third example of my invention is indicated generally at 70. The straw 70 includes a hollow, generally cylindrical portion 72 having a first end 74. In this example, the end 74 is generally square, i.e., it is perpendicular to the axis of the cylinder 72. Opposite the first end 74 of the cylinder 72 there is a second end indicated generally at 76. An edge 78 at the second end 76 of the cylinder 72 is a given distance from the first end 74 of the cylinder 72. A projection 80 extends beyond the edge 78 and terminates in a tip 82 which is more than the given distance from the end 74. In this example, the projection 80 is integral with, but separable from, the cylinder 72. The projection 80 has a width that is less than the diameter of the cylinder 72 and a length that is longer than the diameter of the cylinder 72. Curved portions 84 extend from the edge 78 to sides 86 of the projection 80. In this example, the sides 86 are substantially parallel between the tip 82 and the curved portions 84. In the region where the projection 80 is connected to the cylinder 72, there is a weakened region indicated at 88 which permit the manual removal of the projection 80 from the cylinder 72. The region 88 may include perforations, apertures or slits, indicated at 90 so that the projection 80 may be separated from the cylinder 72, if desired, leaving a fairly conventional straw shape. When the projection 80 is removed from the cylinder 72, the end 76 may be placed at the bottom of a glass so that liquid in the glass may be sucked therefrom. When the projection 80 is connected to the cylinder 72, the end 76 may be placed at the bottom of a glass so that liquid in the glass may be sucked therefrom. However, the projection 80 will resist positioning the end 76 all the way down to the bottom of the glass. This resistance will be more pronounced with the straw 50, for example, because the greater width of the projection 56 where it connects to the cylinder 52 makes the projection stiffer and more difficult to bend than, for example, the projections 20 and 40. In each example, however, the projection 20, 40 or 60 can be bent to some degree so that the end 18, 38, or 58 can be positioned closer to the bottom of glass than the length of the projection 20, 40, or 60. The closer that the end 18, 38, 58, or 78 is to the bottom of the glass, the lower the liquid level will be when no more liquid can be withdrawn through the straw.

Referring now to FIGS. 13, 14, 15, and 16, a straw according to fifth example of my invention is indicated generally at 100. The straw 100 includes a hollow, generally cylindrical portion 102 and a projection 104. A recess 106 in the cylinder 102 is adapted to receive the projection 104 when it is bent along a line 108 and retain it in a retracted position as shown in FIG. 16, where it will not interfere with the bottom of a glass so that all or most all of the liquid in the glass can be withdrawn. A paddle 110 is provided on an end 112 of the cylinder 102 opposite the projection 104. In this case, the end 112 of the cylinder 102 is not square. The paddle 110 has a width that is greater than the diameter of the cylinder 102 while the projection 104 has a width that is less than the diameter of the cylinder 102. The paddle 110 may be used, for example, to extract a slushy substance from a glass.

Referring now to FIGS. 17, 18, and 19, the straw 10 (FIGS. 1, 2, and 3) is shown in a condition where the tip 22 of the projection 20 has been inserted into the cylinder 12 as by bending the projection 20. In this condition, the projection 20 has a shorter effective length so that the end 18 of the cylinder 12 can be placed closer to the bottom of a glass than when the projection 20 is extending outwardly as in FIGS. 1, 2, and 3. The projection 20 can be straightened from the condition shown in FIGS. 17, 18, and 19 by withdrawing the tip 22 from the cylinder 12.

I claim:

1. A drinking straw comprising
a generally cylindrically shaped tube having a first and a second end, said first end being configured to fit into a persons mouth and said second end having a given diameter,
a projection extending from said second end, and
a transition portion between said tube and said projection,
wherein said projection has a length that is greater than the given diameter and wherein said projection has a width along its length that that is less than the given diameter.
